(19) United States
(12) Patent Application Publication
(10) Pub. No.: US 2026/0293991 A1
(43) Pub. Date: Oct. 1, 2026

(54) AN AEROSOL-GENERATING DEVICE WITH A SUSPENDED INDUCTOR COIL

(71) Applicant: Philip Morris Products S.A., Neuchatel (CH)

(72) Inventors: Oleg MIRONOV, Cudrefin (CH); Johannes Petrus Maria PIJNENBURG, Neuchâtel (CH); Enrico STURA, Palézieux-Village (CH); Julien VIDAL, Peseux (CH)

(73) Assignee: Philip Morris Products S.A., Neuchatel (CH)

(21) Appl. No.: 19/479,520

(22) PCT Filed: May 2, 2024
(86) PCT No.: PCT/EP2024/062104

§ 371 Date: Oct. 28, 2025

(30) Foreign Application Priority Data
May 2, 2023 (EP) 23171136.7

(51) Int. Cl. A24F 40/465; A24D 1/20; A24F 40/20; A24F 40/48; H05B 6/36

(52) U.S. Cl. CPC A24F 40/465; A24D 1/20; A24F 40/20; A24F 40/48; H05B 6/36

(57) ABSTRACT

An aerosol-generating device is provided, including: a housing defining a chamber configured to receive an aerosol-generating article; an inductor coil suspended inside the chamber and being a helical coil including first and second ends, and the housing contacting the coil only at the ends; a power supply and control circuitry connected to the coil to provide an alternating electric current to the coil to generate an alternating magnetic field, the housing including an inner surface defining the chamber, an outer surface of the coil being spaced apart from the inner surface of the housing, the chamber including an open first end through which the article is insertable into the chamber and a closed second end opposite the open first end; and an airflow channel defined between the inner and outer surfaces, the channel providing fluid communication between the first and second ends.

The present disclosure relates to an aerosol-generating device for receiving an aerosol-generating article, and an aerosol-generating system comprising the aerosol-generating device.

It is known to evolve an aerosol from an aerosol-forming substrate of an aerosol-generating article by the application of heat to the substrate, without burning or combustion of the substrate. The aerosol-generating article may be cylindrical, like a cigarette, and the aerosol-forming substrate may comprise tobacco material. It is known to apply heat to such an aerosol-generating article to heat the aerosol-forming substrate of the article using a heat source that is external to the aerosol-generating article.

However, an external heat source will tend to heat the aerosol-forming substrate unevenly. The aerosol-forming substrate closest to the heat source will be heated more than the aerosol-forming substrate in the centre of the aerosol-generating article, further from the heat source.

It is also known to heat the aerosol-forming substrate of such an article using a heat source located within the interior of the aerosol-forming substrate. In some aerosol-generating systems the internal heat source is heated inductively using an induction coil positioned externally of the aerosol-generating article and a susceptor material located within a central region of the aerosol-generating article. Internally heating the aerosol-forming substrate avoids heat having to traverse through a wrapper to reach the aerosol-forming substrate. However, internally heating the aerosol-forming substrate also results in the aerosol-forming substrate being heated in a non-uniform manner, with heating of the substrate being greatest at or closest to the internal heat source and reducing with increasing distance away from the internal heat source into the substrate.

Non-uniform heating of the aerosol-forming substrate can mean that not all of the available volatile material is released from the aerosol-forming substrate. This is because increasing the level of heat applied to the substrate in order to fully extract the volatile material from the aerosol-forming substrate when using either external heating or internal heating of the substrate may result in unintended and undesired burning of the substrate close to the heat source, which can give rise to the generation of undesirable compounds and flavours.

It is therefore desired to provide an aerosol-generating device that facilitates efficient and uniform heating of an aerosol-forming substrate without requiring a complex heating arrangement.

According to a first aspect of the disclosure there is provided an aerosol-generating device comprising a housing defining a chamber for receiving at least a portion of an aerosol-generating article. The aerosol-generating device also comprises an inductor coil suspended inside the chamber, and a power supply and control circuitry connected to the inductor coil. The power supply and the control circuitry are configured to provide an alternating electric current to the inductor coil such that, in use, the inductor coil generates an alternating magnetic field.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

The term “suspended” is used herein to refer to arrangements in which less than 50 percent of an outer surface of the inductor coil contacts an inner surface of the chamber. The present inventors have recognised that an inductor coil may exhibit heat losses in the form of resistive heating of the inductor coil when an alternating electric current flows through the inductor coil during use.

Advantageously, positioning the inductor coil inside the chamber may facilitate the transfer of resistively generated heat from the inductor coil to an aerosol-forming substrate of an aerosol-generating article received within the chamber. In embodiments in which the inductor coil is used to inductively heat a susceptor material or element positioned inside an aerosol-forming substrate, advantageously, the inductive heating of the susceptor element and the resistive heating of the inductor coil may provide simultaneous internal and external heating of the aerosol-forming substrate. Advantageously, simultaneous internal and external heating of the aerosol-forming substrate may facilitate more uniform heating of the aerosol-forming substrate.

Advantageously, suspending the inductor coil inside the chamber may reduce or minimise the transfer of resistively generated heat from the inductor coil to the housing. Advantageously, reducing or minimising the transfer of resistively generated heat from the inductor coil to the housing may increase or maximise the transfer of resistively generated heat from the inductor coil to an aerosol-forming substrate.

Preferably, less than 40 percent of the outer surface of the inductor coil contacts the inner surface of the chamber. Preferably, less than 30 percent of the outer surface of the inductor coil contacts the inner surface of the chamber. Preferably, less than 20 percent of the outer surface of the inductor coil contacts the inner surface of the chamber. Preferably, less than 10 percent of the outer surface of the inductor coil contacts the inner surface of the chamber. Preferably, less than 5 percent of the outer surface of the inductor coil contacts the inner surface of the chamber. Preferably, the inductor coil is a helical coil comprising a first end and a second end. Preferably, the housing contacts the inductor coil only at the first end and the second end of the inductor coil. Advantageously, arranging the housing to contact the inductor coil only at the first end and the second end of the inductor coil may minimise conductive heat transfer from the inductor coil to the housing.

The housing may comprises an inner surface at least partially defining the chamber.

Each of the first end of the inductor coil and the second end of the inductor coil may abut the inner surface of the housing. The inner surface of the housing may defines a first recess and a second recess, wherein the first end of the inductor coil is positioned within the first recess and wherein the second end of the inductor coil is positioned within the second recess. Alternatively, the inner surface of the housing may define a first slot and a second slot, wherein the first end of the inductor coil extends through the first slot and wherein the second end of the inductor coil extends through the second slot. Advantageously, the first and second recesses or the first and second slots may facilitate retention and correct positioning of the inductor coil within the chamber.

The inner surface of the housing may be overmolded with respect to the first and second ends of the inductor coil to retain and position the inductor coil within the chamber.

Preferably, the chamber comprises an open first end through which at least a portion of an aerosol-generating article may be inserted into the chamber and a closed second end opposite the open first end.

Preferably, the outer surface of the inductor coil is spaced apart from the inner surface of the housing. Advantageously, the space between the outer surface of the inductor coil and the inner surface of the housing reduces or minimises conductive heat transfer from the inductor coil to the housing. Preferably, the aerosol-generating device further comprises an airflow channel defined between the inner surface of the housing and the outer surface of the inductor coil, wherein the airflow channel provides fluid communication between the first end of the chamber and the second end of the chamber.

Advantageously, using the space between the inner surface of the housing and the outer surface of the inductor coil as an airflow channel may eliminate the need to provide a more complex airflow arrangement within the chamber. For example, the inner surface of the housing may form a cylindrical wall of the chamber, wherein the cylindrical wall has a substantially smooth and continuous surface.

Advantageously, using the space between the inner surface of the housing and the outer surface of the inductor coil as an airflow channel may further reduce or minimise the transfer of heat from the inductor coil to the housing. Advantageously, heat losses from the outer surface of the inductor coil may be absorbed by airflow through the airflow channel so that the heated airflow is received by an aerosol-forming substrate received within the chamber.

Preferably, the annular gap has a number average width in a radial direction of at least 0.5 millimetres, or at least 1 millimetre, or at least 1.5 millimetres, or at least 2 millimetres. Preferably, the annular gap has a number average width in a radial direction of less than 5 millimetres, or less than 4 millimetres, or less than 3 millimetres, or less than 2 millimetres.

Preferably, the aerosol-generating device comprises a pressure sensor in fluid communication with the airflow channel defined by the annular gap. Advantageously, the relatively narrow airflow channel defined by the annular gap may amplify a pressure drop created when a user draws on an aerosol-generating system comprising the aerosol-generating device. Advantageously, the amplified pressure drop may increase the sensitivity of the pressure sensor to puffing by the user.

Preferably, the pressure sensor is configured to provide a signal to the control circuitry indicative of a user drawing on an aerosol-generating system comprising the aerosol-generating device.

Preferably, the aerosol-generating device comprises at least one protrusion extending into the chamber from the closed second end of the chamber. Advantageously, the at least one protrusion may abut an upstream end of an aerosol-generating article received within the chamber to space the upstream end of the aerosol-generating article apart from the closed end of the chamber. Advantageously, spacing the upstream end of the aerosol-generating article from the closed end of the chamber may facilitate airflow into the aerosol-generating article during use.

Preferably, the housing comprises an end wall defining the closed second end of the chamber, wherein the at least one protrusion extends into the chamber from the end wall. Preferably, the at least one protrusion is formed integrally with the end wall.

Preferably, the at least one protrusion comprises at least three protrusions. Advantageously, providing at least three protrusions may facilitate secure and correct positioning of an aerosol-generating article in the chamber. Preferably, the chamber has a longitudinal axis defining a first direction along which at least a portion of an aerosol-generating article may be inserted into the chamber, wherein the at least three protrusions are equidistantly spaced from each other in a circumferential direction around the longitudinal axis.

The aerosol-generating device may comprise a susceptor element. Advantageously, providing a susceptor element as part of the aerosol-generating device may eliminate the need to provide each aerosol-generating article with a susceptor element. Advantageously, this may reduce the cost of each aerosol-generating article.

As used herein, the term “susceptor element” refers to an element comprising a material that is capable of converting the energy of a magnetic field into heat. When a susceptor element is located in an alternating magnetic field, the susceptor is inductively heated. Heating of the susceptor may be the result of at least one of hysteresis losses and eddy currents induced in the susceptor, depending on the electrical and magnetic properties of the susceptor material.

Preferably, the susceptor element is an elongate susceptor element. Preferably, the elongate susceptor element extends into the chamber from the closed second end of the chamber. Preferably, at least a portion of the elongate susceptor element is positioned inside the inductor coil.

The susceptor element may be formed from any material that can be inductively heated to a temperature sufficient to aerosolise an aerosol-forming substrate. Suitable materials for the susceptor element include graphite, molybdenum, silicon carbide, stainless steels, niobium, and aluminium. Preferred susceptor elements comprise a metal or carbon. Preferably, the susceptor element comprises or consists of a ferromagnetic material, for example, ferritic iron, a ferromagnetic alloy, such as ferromagnetic steel or stainless steel, ferromagnetic particles, and ferrite. A suitable susceptor element may be, or comprise, aluminium. The susceptor element preferably comprises more than about 5 percent, preferably more than about 20 percent, more preferably more than about 50 percent or more than 90 percent of ferromagnetic or paramagnetic materials. Preferred susceptor elements may be heated to a temperature in excess of about 250 degrees Celsius.

The susceptor element may comprise a non-metallic core with a metal layer disposed on the non-metallic core. For example, the susceptor element may comprise one or more metallic tracks formed on an outer surface of a ceramic core or substrate.

The susceptor element may have a protective external layer, for example a protective ceramic layer or protective glass layer. The protective external layer may encapsulate the susceptor element. The susceptor element may comprise a protective coating formed by a glass, a ceramic, or an inert metal, formed over a core of susceptor material.

The susceptor element may have any suitable cross-section. For example, the susceptor element may have a square, oval, rectangular, triangular, pentagonal, hexagonal, or similar cross-sectional shape. The susceptor element may have a planar or flat cross-sectional shape.

The susceptor element may be solid, hollow, or porous. Preferably, the susceptor element is solid.

In embodiments in which the susceptor element has a planar or flat cross-sectional shape, preferably the susceptor element has a thickness of between about 1 millimetre and about 8 millimetres, more preferably from about 3 millimetres to about 5 millimetres. The thickness of the susceptor element is measured in a longitudinal direction of the aerosol-generating device. Preferably, the susceptor element has a width or a diameter of between about 3 millimetres and about 12 millimetres, more preferably between about 4 millimetres and about 10 millimetres, more preferably between about 5 millimetres and about 8 millimetres. The width or diameter of the susceptor element is orthogonal to its thickness.

In embodiments in which the susceptor element is an elongate susceptor element, preferably the elongate susceptor element is in the form of a pin, rod, blade, or plate. Preferably, the elongate susceptor element has a length of between about 5 millimetres and about 15 millimetres, for example between about 6 millimetres and about 12 millimetres, or between about 8 millimetres and about 10 millimetres. The elongate susceptor element preferably has a width of between about 1 millimetre and about 8 millimetres, more preferably from about 3 millimetres to about 5 millimetres. The elongate susceptor element may have a thickness of from about 0.01 millimetres to about 2 millimetres. If the elongate susceptor element has a constant cross-section, for example a circular cross-section, it has a preferable width or diameter of between about 1 millimetre and about 5 millimetres.

Preferably, the inductor coil is arranged so that, when an aerosol-generating article is inserted into the chamber, at least part of the aerosol-generating article is received within the inductor coil. Preferably, the inductor coil is arranged so that, when an aerosol-generating article is inserted into the chamber, the inductor coil directly contacts the aerosol-generating article. Advantageously, direct contact between the inductor coil and an aerosol-generating article facilitates the conductive transfer of resistively generated heat from the inductor coil to the aerosol-generating article.

The inductor coil may be formed from a coiled wire. The wire may comprise an electrically conductive core and a coating on the electrically conductive core. Preferably, the coating is electrically insulating. Advantageously, an electrically insulating coating may prevent electrical short circuit between adjacent windings of the inductor coil. Advantageously, an electrically insulating coating may electrically isolate the inductor coil from an aerosol-generating article received within the inductor coil. The coating may comprise at least one of a polymer, a ceramic, and a glass. The coating may comprise parylene.

The coiled wire may have a square, rectangular, or flat cross-sectional profile. Advantageously, forming the inductor coil from a coiled wire having a square, rectangular or flat cross-sectional profile may increase or maximise the surface area of the inductor coil in contact with an aerosol-generating article in embodiments in which the inductor coil is arranged to directly contact the aerosol-generating article.

The term “electrically conductive” is used herein to refer to materials having an electrical conductivity of at least 0.8×10⁶ Siemens per metre. The term “electrically insulating” is used herein to refer to materials having an electrical conductivity of less than 0.8×10⁴ Siemens per metre.

The inductor coil may be formed from any suitable electrically conductive material. Preferably, the inductor coil is formed from a metal or a metal alloy. The inductor coil may be formed from at least one of copper, a copper alloy, a copper-nickel alloy, tungsten, aluminium, an aluminium alloy, and a steel. Suitable steels include stainless steels, such as 316 stainless steels. In embodiments in which the inductor coil comprises an electrically conductive core, the metal or the metal alloy may form the electrically conductive core.

The power supply may be a DC power supply. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts).

The power supply may be configured to operate at high frequency. As used herein, the term “high frequency oscillating current” means an oscillating current having a frequency of between about 500 kilohertz and about 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

The aerosol-generating device comprises control circuitry connected to the inductor coil and the power supply. The control circuitry is configured to control the supply of power to the inductor coil from the power supply. The control circuitry may comprise a microprocessor, which may be a programmable microprocessor, a microcontroller, or an application specific integrated chip (ASIC) or other electronic circuitry capable of providing control. The control circuitry may comprise further electronic components. The control circuitry may be configured to regulate a supply of current to the inductor coil. Current may be supplied to the inductor coil continuously following activation of the aerosol-generating device or may be supplied intermittently, such as on a puff by puff basis. The control circuitry may advantageously comprise DC/AC inverter, which may comprise a Class-D or Class-E power amplifier.

The control circuitry may be configured to supply electric energy from the power supply to the inductor coil as an alternating current such that the inductor coil is operable to generate heat through one or a combination of i) resistive heating of the inductor coil and ii) heating of a susceptor element through inductive coupling of the inductor coil with the susceptor. The control circuitry may be configured to adjust at least one parameter of the alternating current to change the inductive coupling of the inductor coil with the susceptor element, thereby adjusting the balance of heat generated through inductive coupling of the inductor coil with the susceptor element relative to heat generated through resistive heating of the inductor coil.

As used herein, the term “inductively couple” refers to the heating of a susceptor element when penetrated by an alternating magnetic field. The heating may be caused by the generation of eddy currents in the susceptor element. The heating may be caused by magnetic hysteresis losses.

Preferably, the at least one parameter comprises a frequency of the alternating current. The inductive coupling between the inductor coil and susceptor element varies with changes in the frequency of the alternating current. The frequency may be adjusted to have a value f_{susceptor}, associated with an alternating current creating an alternating magnetic field that provides optimum coupling with the susceptor element to allow transfer of almost the totality of the energy from the inductor coil to the susceptor element, resulting in most of the heat being generated by inductive heating of the susceptor element. The frequency may also be adjusted to have a value f_{inductor coil}, associated with an alternating current creating an alternating magnetic field that provides little to no coupling with the susceptor element and allows almost the totality of the energy to remain within the inductor coil, resulting in most of the heat being generated by resistive heating of the inductor coil. The frequency may also be adjusted to have a value fₜₒₜₐₗ, associated with an alternating current which results in a combination of inductive heating of the susceptor element and resistive heating of the inductor coil. Each of these frequencies will vary depending on the materials, physical properties and configuration of the inductor coil and the susceptor element, such as the inductance of the inductor coil and the magnetic permeability of the material or materials from which the susceptor element is formed.

The control circuitry may be configured to provide an alternating current to the inductor coil, such that the inductor coil generates an alternating magnetic field to inductively heat a susceptor element in an aerosol-generating article, and to provide a direct current to the inductor coil to resistively heat the inductor coil and thereby conductively heat the aerosol-generating article. Advantageously, using a single coil to provide both heating power to an internal susceptor and to provide resistive heating of the coil itself provides two different heat sources in different locations relative to the aerosol-forming substrate with a structure that is no more complex than a typical induction heating arrangement.

The control circuitry may be configured to adjust the alternating current provided to the inductor coil during operation of the aerosol-generating device to adjust an amount of heating provided by inductive heating.

The control circuitry may be configured to adjust the direct current provided to the inductor coil during operation of the aerosol-generating device to adjust an amount of heating provided by resistive heating.

The control circuitry may be configured to provide the alternating current and the direct current to the inductor coil at different times. For example, following activation of the aerosol-generating device the control circuitry may be configured to initially provide alternating current to the inductor coil and to subsequently provide direct current to the inductor coil. This may provide for rapid generation of aerosol at the outset of a usage session, but also provide for complete and efficient heating of the entire aerosol-forming substrate over a full usage session. At the beginning of a usage session, inductive heating of an internal susceptor may provide aerosol more quickly than external resistive heating because the susceptor can be in closer contact with the aerosol-forming substrate. An internal susceptor may also be heated more quickly than the external inductor coil if the susceptor has a lower thermal mass than the inductor coil.

The control circuitry may be configured to provide the alternating current and the direct current to the inductor coil in an alternating sequence. It may be beneficial to alternate external and internal heating in order to avoid overheating of any part of the aerosol-forming substrate.

The control circuitry may be configured to provide both alternating current and direct current to the inductor coil concurrently. In this way a larger amount of heat energy can be transferred to the aerosol-forming substrate to generate a larger volume of aerosol, without either the susceptor or the inductor coil reaching a temperature at which any part of the aerosol-generating article might combust.

An aerosol-generating device comprising control circuitry configured to vary at least one parameter of an alternating electric current, or configured to provide both alternating current and direct current to the inductor coil, is able to change the mode of application of heat to an aerosol-forming substate according to any one of the following heating regimes:
a) solely or predominantly through the resistive heating of the inductor coil;
b) solely or predominantly through heating of a susceptor element through the inductive coupling of the inductor coil with the susceptor element;
c) a combination of resistive heating of the inductor coil and heating of a susceptor element through the inductive coupling of the inductor coil with the susceptor element.

Preferably, the aerosol-generating device is portable. The aerosol-generating device may have a size comparable to a conventional cigar or cigarette. The aerosol-generating device may have a total length between approximately 30 millimetres and approximately 150 millimetres. The aerosol-generating device may have an external diameter between approximately 5 millimetres and approximately 30 millimetres.

The aerosol-generating device housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise a mouthpiece. The mouthpiece may comprise at least one air inlet and at least one air outlet. The mouthpiece may comprise more than one air inlet. One or more of the air inlets may reduce the temperature of the aerosol before it is delivered to a user and may reduce the concentration of the aerosol before it is delivered to a user.

Alternatively, the mouthpiece may be provided as part of an aerosol-generating article.

As used herein, the term “mouthpiece” refers to a portion of an aerosol-generating device that is placed into a user's mouth in order to directly inhale an aerosol generated by the aerosol-generating device from an aerosol-generating article received in the chamber of the housing.

The aerosol-generating device may include a user interface to activate the device, for example a button to initiate heating of the device or display to indicate a state of the device or of the aerosol-forming substrate.

According to a second aspect of the present disclosure, there is provided an aerosol-generating device comprising a housing defining a chamber for receiving at least a portion of an aerosol-generating article. The aerosol-generating device also comprises an inductor coil positioned inside the chamber, wherein the inductor coil is a helical coil comprising a first end and a second end, and wherein the housing contacts the inductor coil only at the first end and the second end of the inductor coil. The aerosol-generating device also includes a power supply and control circuitry connected to the inductor coil and configured to provide an alternating electric current to the inductor coil such that, in use, the inductor coil generates an alternating magnetic field.

Advantageously, positioning the inductor coil inside the chamber may facilitate the transfer of resistively generated heat from the inductor coil to an aerosol-forming substrate of an aerosol-generating article received within the chamber. In embodiments in which the inductor coil is used to inductively heat a susceptor material or element positioned inside an aerosol-forming substrate, advantageously, the inductive heating of the susceptor element and the resistive heating of the inductor coil may provide simultaneous internal and external heating of the aerosol-forming substrate. Advantageously, simultaneous internal and external heating of the aerosol-forming substrate may facilitate more uniform heating of the aerosol-forming substrate.

Advantageously, arranging the inductor coil inside the chamber so that only the first and second ends of the inductor coil contact the housing may reduce or minimise the transfer of resistively generated heat from the inductor coil to the housing. Advantageously, reducing or minimising the transfer of resistively generated heat from the inductor coil to the housing may increase or maximise the transfer of resistively generated heat from the inductor coil to an aerosol-forming substrate.

The aerosol-generating device may comprise any of the optional or preferred features described above with respect to the first aspect of the present disclosure.

According to a third aspect of the present disclosure there is provided an aerosol-generating system. The aerosol-generating system comprises an aerosol-generating device according to the first aspect of the present disclosure or the second aspect of the present disclosure, in accordance with any of the embodiments described herein. The aerosol-generating system also comprises an aerosol-generating article comprising an aerosol-forming substrate.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-forming substrate” refers to a substrate consisting of or comprising an aerosol-forming material that is capable of releasing volatile compounds upon heating to generate an aerosol.

The aerosol-generating article may comprise an article susceptor element. Preferably, the article susceptor element is positioned in direct contact with the aerosol-forming substrate. Preferably, the article susceptor element is an internal susceptor element positioned within the aerosol-forming substrate.

Preferably, the aerosol-generating article is configured so that at least a portion of the article susceptor element is positioned within the inductor coil when the aerosol-generating article is inserted into the chamber of the aerosol-generating device.

The article susceptor element may comprise any of the optional or preferred features described above with respect to a susceptor element forming part of the aerosol-generating device.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate. Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di-or triacetate; and aliphatic esters of mono-, di-or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating device comprising:
a housing defining a chamber for receiving at least a portion of an aerosol-generating article;
an inductor coil suspended inside the chamber; and
a power supply and control circuitry connected to the inductor coil and configured to provide an alternating electric current to the inductor coil such that, in use, the inductor coil generates an alternating magnetic field.

Example Ex 2: An aerosol-generating device according to Example 1, wherein the inductor coil is a helical coil comprising a first end and a second end.

Example Ex 3: An aerosol-generating device according to Example 2, wherein the housing contacts the inductor coil only at the first end and the second end of the inductor coil.

Example Ex 4: An aerosol-generating device according to Example 1, 2 or 3 wherein the housing comprises an inner surface at least partially defining the chamber.

Example Ex 5: An aerosol-generating device according to the combination of Example 4 with Example 2 or Example 3, wherein each of the first end of the inductor coil and the second end of the inductor coil abuts the inner surface of the housing.

Example Ex 6: An aerosol-generating device according to Example 5, wherein the inner surface of the housing defines a first recess and a second recess, wherein the first end of the inductor coil is positioned within the first recess and wherein the second end of the inductor coil is positioned within the second recess.

Example Ex 7: An aerosol-generating device according to Example 5, wherein the inner surface of the housing defines a first slot and a second slot, wherein the first end of the inductor coil extends through the first slot and wherein the second end of the inductor coil extends through the second slot.

Example Ex 8: An aerosol-generating device according to any of Examples 4 to 7, wherein an outer surface of the inductor coil is spaced apart from the inner surface of the housing.

Example Ex9: An aerosol-generating device according to any preceding Example, wherein the chamber comprises an open first end through which at least a portion of an aerosol-generating article may be inserted into the chamber and a closed second end opposite the open first end.

Example Ex10: An aerosol-generating device according to the combination of Examples 8 and 9, further comprising an airflow channel defined between the inner surface of the housing and the outer surface of the inductor coil, wherein the airflow channel provides fluid communication between the first end of the chamber and the second end of the chamber.

Example Ex 11: An aerosol-generating device according to Example 9 or 10, further comprising at least one protrusion extending into the chamber from the closed second end of the chamber.

Example Ex 12: An aerosol-generating device according to Example 11, wherein the housing comprises an end wall defining the closed second end of the chamber, and wherein the at least one protrusion extends into the chamber from the end wall.

Example Ex 13: An aerosol-generating device according to Example 12, wherein the at least one protrusion is formed integrally with the end wall.

Example Ex 14: An aerosol-generating device according to Example 11, 12 or 13, wherein the at least one protrusion comprises at least three protrusions.

Example Ex 15: An aerosol-generating device according to Example 14, wherein the chamber has a longitudinal axis defining a first direction along which at least a portion of an aerosol-generating article may be inserted into the chamber, and wherein the at least three protrusions are equidistantly spaced from each other in a circumferential direction around the longitudinal axis.

Example Ex 16: An aerosol-generating device according to any of Examples 9 to 15, further comprising an elongate susceptor element extending into the chamber from the closed second end of the chamber.

Example Ex 17: An aerosol-generating device according to Example 16, wherein at least a portion of the elongate susceptor element is positioned inside the inductor coil.

Example Ex18: An aerosol-generating device according to any preceding Example, wherein the inductor coil is arranged so that, when an aerosol-generating article is inserted into the chamber, at least part of the aerosol-generating article is received within the inductor coil.

Example Ex19: An aerosol-generating device according to any preceding Example, wherein the inductor coil is arranged so that, when an aerosol-generating article is inserted into the chamber, the inductor coil directly contacts the aerosol-generating article.

Example Ex20: An aerosol-generating device according to any preceding Example, wherein the inductor coil is formed from a coiled wire, the wire comprising an electrically conductive core and a coating on the electrically conductive core.

Example Ex21: An aerosol-generating device according to any preceding Example, wherein the coating is electrically insulating.

Example Ex 22: An aerosol-generating device according to Example 20 or 21, wherein the coating comprises at least one of a polymer, a ceramic, and a glass.

Example Ex 23: An aerosol-generating device according to Example 22, wherein the coating comprises parylene.

Example Ex24: An aerosol-generating device according to any preceding Example, wherein the inductor coil comprises a metal.

Example Ex 25: An aerosol-generating device according to Example 24, wherein the metal comprises at least one of copper, a copper alloy, a copper-nickel alloy, tungsten, aluminium, an aluminium alloy, and a steel.

Example Ex26: An aerosol-generating device according to any of Examples 20 to 23 in combination with Example 24 or 25, wherein the metal forms the electrically conductive core.

Example Ex27: An aerosol-generating system comprising:
an aerosol-generating device according to any preceding Example; and
an aerosol-generating article comprising an aerosol-forming substrate.

Example Ex 28: An aerosol-generating system according to Example 27, wherein the aerosol-generating article further comprises an article susceptor element.

Example Ex 29: An aerosol-generating system according to Example 28, wherein the aerosol-generating article is configured so that at least a portion of the article susceptor element is positioned within the inductor coil when the aerosol-generating article is inserted into the chamber.

Example Ex30: An aerosol-generating device comprising:
a housing defining a chamber for receiving at least a portion of an aerosol-generating article;
an inductor coil positioned inside the chamber, wherein the inductor coil is a helical coil comprising a first end and a second end, and wherein the housing contacts the inductor coil only at the first end and the second end of the inductor coil; and
a power supply and control circuitry connected to the inductor coil and configured to provide an alternating electric current to the inductor coil such that, in use, the inductor coil generates an alternating magnetic field.

Example Ex 31: An aerosol-generating device according to Example 30, the aerosol-generating device further including at least one of the features of Examples 4 to 26.

Example Ex32: An aerosol-generating system comprising:
an aerosol-generating device according to Example 30 or 31; and
an aerosol-generating article comprising an aerosol-forming substrate.

Example Ex 33: An aerosol-generating system according to Example 32, wherein the aerosol-generating article further comprises an article susceptor element.

Example Ex 34: An aerosol-generating system according to Example 33, wherein the aerosol-generating article is configured so that at least a portion of the article susceptor element is positioned within the inductor coil when the aerosol-generating article is inserted into the chamber.

The invention is further described, by way of example only, with reference to the accompanying drawings in which:

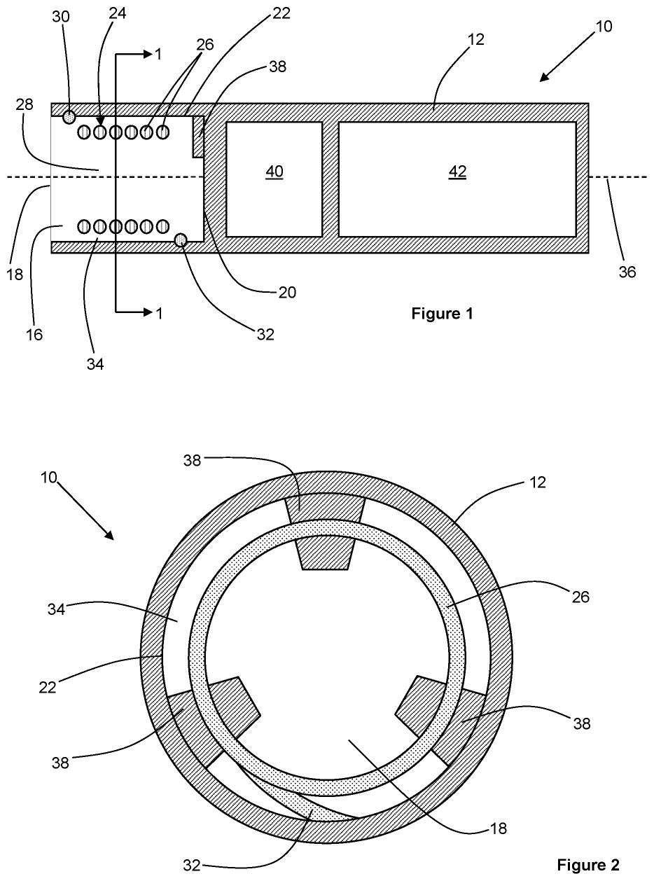

FIG. 1 shows a side cross-sectional view of an aerosol-generating device according to a first embodiment of the present invention;

FIG. 2 shows an axial cross-sectional view of the aerosol-generating device of FIG. 1 along line 1-1;

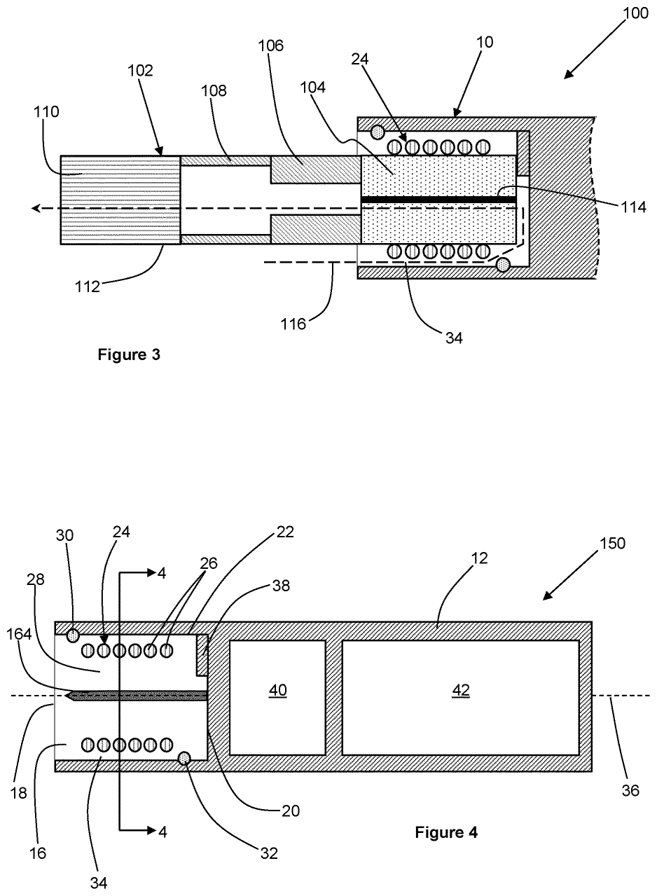

FIG. 3 shows a side cross-sectional view of an aerosol-generating system comprising the aerosol-generating device of FIG. 1;

FIG. 4 shows a side cross-sectional view of an aerosol-generating device according to a second embodiment of the present invention; and

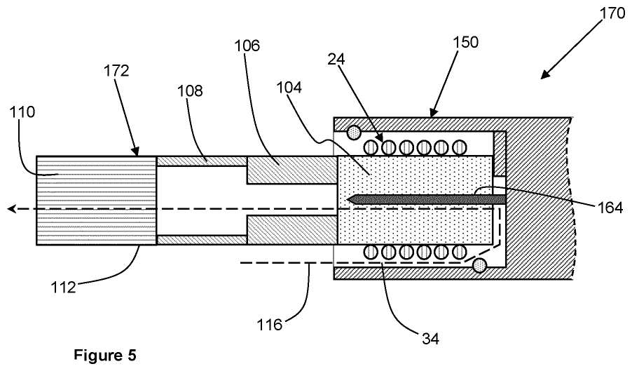

FIG. 5 shows a side cross-sectional view of an aerosol-generating system comprising the aerosol-generating device of FIG. 4.

FIGS. 1 and 2 show an aerosol-generating device 10 in accordance with a first embodiment of the present invention. The aerosol-generating device 10 comprises a housing 12 defining a chamber 16 for receiving a portion of an aerosol-generating article. The chamber 16 comprises an open end 18 through which an aerosol-generating article may be inserted into the chamber 16 and a closed end 20 opposite the open end 18. A cylindrical wall 22 of the chamber 16 extends between the open end 18 and the closed end 20.

The aerosol-generating device 10 also comprises an inductor coil 24 comprising a plurality of windings 26 disposed within the chamber 16. The plurality of windings 26 of the inductor coil 24 define a lumen 28 in which a portion of an aerosol-generating article is received when the aerosol-generating article is inserted into the chamber 16. Advantageously, positioning the inductor coil 24 in direct contact with an aerosol-generating article received within the chamber 16 facilitates the transfer of heat generated by resistive heating of the inductor coil 24 to the aerosol-generating article.

The inductor coil 24 comprises a first end 30 positioned towards the open end 18 of the chamber 16 and a second end 32 positioned towards the closed end 20 of the chamber 16. Each of the first end 30 and the second end 32 is received within a portion of the cylindrical wall 22 of the chamber 16 to retain the inductor coil 24 within the chamber 16. The cylindrical wall 22 of the chamber 16 may define first and second recesses, slots, or apertures in which the first and second ends 30, 32 of the inductor coil 24 are respectively received. Alternatively, the first and second ends 30, 32 of the inductor coil 24 may be secured to the cylindrical wall 22 of the chamber 16 by overmolding the housing 12 over the first and second ends 30, 32 of the inductor coil 24 during manufacture of the housing 12.

The inductor coil 24 is suspended within the chamber 16 by the first and second ends 30, 32 of the inductor coil 24 so that the windings 26 of the inductor coil 24 are spaced apart from the cylindrical wall 22 of the chamber 16. Therefore, the inductor coil 24 contacts the housing 12 only at the first and second ends 30, 32 of the inductor coil 24. Spacing the windings 26 of the inductor coil 24 from the cylindrical wall 22 of the chamber 16 defines an annular gap 34 between the cylindrical wall 22 of the chamber 16 and the windings 26 of the inductor coil 24. Advantageously, the annular gap 34 reduces or minimises the transfer of heat generated by resistive heating of the inductor coil 24 to the housing 12. Advantageously, the annular gap 34 facilitates airflow through the chamber 16 when an aerosol-generating article is received within the chamber 16. To facilitate insertion of an aerosol-generating article into the chamber 16, the inductor coil 24 is arranged concentrically about a central axis 36 of the aerosol-generating device 10. To facilitate a secure positioning of the inductor coil 24 in the chamber 16, the first and second ends 30, 32 of the inductor coil 24 are retained by diametrically opposed portions of the cylindrical wall 22 of the chamber 16.

The housing 12 also defines a plurality of protrusions 38 extending into the chamber 16 from the closed end 20 of the chamber 16. As will be further described below, the plurality of protrusions 38 function to maintain a gap between an end of an aerosol-generating article and the closed end 20 of the chamber 16 when the aerosol-generating article is fully inserted into the chamber 16. In the embodiment shown in FIGS. 1 and 2, the housing 12 defines three protrusions 38 spaced equidistantly about the central axis 36 of the aerosol-generating device 10. The skilled person will appreciate that the housing 12 may define more or fewer protrusions 38 and the arrangement of the protrusions 38 at the closed end 20 of the chamber 16 may be varied. The aerosol-generating device 10 also comprises control circuitry 40 and a power supply 42 connected to the inductor coil 24. The control circuitry 40 is configured to provide an alternating electric current from the power supply 42 to the inductor coil 24 to generate an alternating magnetic field.

FIG. 3 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube 106, a second hollow acetate tube 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the chamber 16 and the inductor coil 24 so that the aerosol-forming substrate 104 and the susceptor element 114 are positioned inside the inductor coil 24. The control circuitry 40 provides an alternating electric current from the power supply 42 to the inductor coil 24 to generate an alternating magnetic field that inductively heats the susceptor element 114, which heats the aerosol-forming substrate 104 to generate an aerosol.

Airflow through the aerosol-generating system 100 during use is illustrated by the dashed line 116 in FIG. 3. When a user draws on the mouthpiece 110 of the aerosol-generating article 102, a negative pressure is generated in the chamber 16. The negative pressure draws air into the chamber 16 at the open end 18 of the chamber. The air entering the chamber 16 then flows through the annular gap 34 between the inductor coil 24 and the cylindrical wall 22 of the chamber 16. When the airflow reaches the closed end 20 of the chamber 16, the air enters the aerosol-generating article 102 through the aerosol-forming substrate 104. Airflow into the aerosol-generating article 102 is facilitated by the gap maintained between the upstream end of the aerosol-generating article 102 and the closed end 20 of the chamber 16 by the plurality of protrusions 38. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 4 shows a cross-sectional view of an aerosol-generating device 150 according to a second embodiment of the invention. The aerosol-generating device 150 is similar to the aerosol-generating device 10 described with reference to FIGS. 1 and 2 and like reference numerals are used to designate like parts.

The aerosol-generating device 150 differs from the aerosol-generating device 10 by the addition of a susceptor element 164. The susceptor element 164 has an elongate shape and extends into the chamber 16 from the closed end 20 of the chamber 16. The susceptor element 164 extends along the central axis 36 of the aerosol-generating device 150 so that the inductor coil 24 extends concentrically around the susceptor element 164.

FIG. 5 shows a cross-sectional view of an aerosol-generating system 170 comprising the aerosol-generating device 150 of FIG. 4 and an aerosol-generating article 172. The aerosol-generating system 170 is similar to the aerosol-generating system 100 described with reference to FIG. 3 and like reference numerals are used to designate like parts.

The aerosol-generating system 170 differs by the absence of a susceptor element in the aerosol-generating article 172. When the aerosol-generating article 172 is inserted into the chamber 16, the susceptor element 164 of the aerosol-generating device 150 is received within the aerosol-forming substrate 104 of the aerosol-generating article 172. Once the aerosol-generating article 172 has been inserted into the chamber 16, the operation of the aerosol-generating system 170 is identical to the operation of the aerosol-generating system 100 described with reference to FIG. 3.

1.-15. (canceled)

16. An aerosol-generating device, comprising:
a housing defining a chamber configured to receive at least a portion of an aerosol-generating article;
an inductor coil suspended inside the chamber, wherein the inductor coil is a helical coil comprising a first end and a second end, and wherein the housing contacts the inductor coil only at the first end and the second end of the inductor coil;
a power supply and control circuitry connected to the inductor coil and configured to provide an alternating electric current to the inductor coil to generate an alternating magnetic field,
wherein the housing comprises an inner surface at least partially defining the chamber,
wherein an outer surface of the inductor coil is spaced apart from the inner surface of the housing,
wherein the chamber comprises an open first end through which at least a portion of the aerosol-generating article is insertable into the chamber and a closed second end opposite the open first end; and
an airflow channel defined between the inner surface of the housing and the outer surface of the inductor coil, wherein the airflow channel provides fluid communication between the first end of the chamber and the second end of the chamber.

17. The aerosol-generating device according to claim 16, wherein the inner surface of the housing forms a cylindrical wall of the chamber.

18. The aerosol-generating device according to claim 17, wherein the cylindrical wall of the chamber has a smooth and continuous surface.

19. The aerosol-generating device according to claim 16, wherein each of the first end of the inductor coil and the second end of the inductor coil abuts the inner surface of the housing.

20. The aerosol-generating device according to claim 19,
wherein the inner surface of the housing defines a first recess and a second recess,
wherein the first end of the inductor coil is positioned within the first recess, and
wherein the second end of the inductor coil is positioned within the second recess.

21. The aerosol-generating device according to claim 19,
wherein the inner surface of the housing defines a first slot and a second slot,
wherein the first end of the inductor coil extends through the first slot, and
wherein the second end of the inductor coil extends through the second slot.

22. The aerosol-generating device according to claim 16, further comprising at least one protrusion extending into the chamber from the closed second end of the chamber.

23. The aerosol-generating device according to claim 16, further comprising an elongate susceptor element extending into the chamber.

24. The aerosol-generating device according to claim 23, wherein at least a portion of the elongate susceptor element is positioned inside the inductor coil.

25. The aerosol-generating device according to claim 16, wherein the inductor coil is formed from a coiled wire, the coiled wire comprising an electrically conductive core and a coating on the electrically conductive core.

26. The aerosol-generating device according to claim 25, wherein the coating is electrically insulating.

27. An aerosol-generating system, comprising:
the aerosol-generating device according to claim 16; and
an aerosol-generating article comprising an aerosol-forming substrate.

28. The aerosol-generating system according to claim 27, wherein the aerosol-generating article further comprises an article susceptor element.
